(19) United States
(12) Patent Application Publication
(10) Pub. No.: US 2025/0231398 A1
(43) Pub. Date: Jul. 17, 2025

(54) OPTICAL SCANNING DEVICE

(71) Applicant: FUJIFILM Corporation, Tokyo (JP)

(72) Inventors: Yosuke NISHIURA, Kanagawa (JP); Takayuki NAONO, Kanagawa (JP)

(73) Assignee: FUJIFILM Corporation, Tokyo (JP)

(21) Appl. No.: 19/097,122

(22) Filed: Apr. 1, 2025

Related U.S. Application Data
(63) Continuation of application No. PCT/JP2023/033718, filed on Sep. 15, 2023.

(30) Foreign Application Priority Data
Oct. 14, 2022 (JP) 2022-165596

(51) Int. Cl. G02B 26/08; G02B 26/10

(52) U.S. Cl. CPC G02B 26/0833; G02B 26/101

(57) ABSTRACT

An optical scanning device of the present disclosure includes a micromirror device that includes a mirror portion, a first actuator allowing the mirror portion to swing around a first axis, and a second actuator allowing the mirror portion to swing around a second axis orthogonal to the first axis, a light source that emits a light beam, a first photodetection element and a second photodetection element that detect a position in a one-dimensional direction of the light beam reflected by the mirror portion, and a processor that calculates, based on detection signals output from the first photodetection element and the second photodetection element, an amplitude of the mirror portion around the first axis, an amplitude of the mirror portion around the second axis, and a phase difference between the swing of the mirror portion around the first axis and the swing of the mirror portion around the second axis.

### CROSS-REFERENCE TO RELATED APPLICATIONS

This application is a continuation application of International Application No. PCT/JP2023/033718, filed Sep. 15, 2023, the disclosure of which is incorporated herein by reference in its entirety. Further, this application claims priority from Japanese Patent Application No. 2022-165596, filed on Oct. 14, 2022, the disclosure of which is incorporated herein by reference in its entirety.

### BACKGROUND

### 1. Technical Field

The technology of the present disclosure relates to an optical scanning device.

### 2. Description of the Related Art

A micromirror device (also referred to as a microscanner) is known as one of micro electro mechanical systems (MEMS) devices manufactured using the silicon (Si) microfabrication technique. The micromirror device is driven by a driving controller provided in an optical scanning device. By driving a mirror portion of the micromirror device, the driving controller two-dimensionally scans an object with a light beam reflected by the mirror portion.

An optical scanning method using the micromirror device is superior to an optical scanning method using a polygon mirror in the related art in terms of small size, light weight, and low power consumption. Therefore, application of the micromirror device to a light detection and ranging (LiDAR) device, a scanning beam display, and the like is attracting attention.

In such an optical scanning device, the light beam is deflected by changing an angle of the mirror portion. Therefore, in order to grasp a scanning position of the light beam in the object, it is necessary to detect a motion of the mirror portion. As an example of a method of detecting the motion of the mirror portion, a method of providing a strain sensor in the vicinity of the mirror portion and calculating the angle of the mirror portion based on an output value of the strain sensor is known. However, since the strain sensor detects a change in physical properties of a material, detection sensitivity has temperature dependence and changes due to deterioration of the material. Therefore, a detection accuracy of the motion of the mirror portion through the strain sensor is low.

As another method of detecting the motion of the mirror portion, a method of detecting the angle of the mirror portion by irradiating a back surface of the mirror portion with a light beam is known. JP2021-025938A proposes a configuration in which a light source that emits a light beam parallel to the back surface of the mirror portion that has been subjected to anti-reflection processing, and a photodetector provided on an optical path of a light beam are provided, in which the angle of the mirror portion is detected based on a light-receiving result of the photodetector. The angle of the mirror portion can be detected based on the fact that the amount of light received by the photodetector changes as the back surface of the mirror portion blocks the light beam in a case in which the mirror portion is inclined. In addition, JP2012-198511A proposes a configuration in which the angle of the mirror portion is detected by irradiating the back surface of the mirror portion with a light beam and measuring a position of the light beam reflected by the back surface using a two-dimensional position detection element.

### SUMMARY

However, in the method disclosed in JP2021-025938A, the light beam is emitted parallel to the back surface of the mirror portion, so that the motion of the mirror portion cannot be detected with high accuracy. In addition, in the method disclosed in JP2021-025938A, the back surface of the mirror portion needs to be subjected to the anti-reflection processing, so that there is a problem in that the number of manufacturing steps required to manufacture the micromirror device increases, resulting in increased manufacturing cost.

In addition, in the method disclosed in JP2012-198511A, the two-dimensional position detection element detects the position of the light beam reflected by the back surface of the mirror portion, making it possible to detect the motion of the mirror portion with high accuracy, but there is a problem in that the optical scanning device is very expensive due to the use of the two-dimensional position detection element.

An object of the technology of the present disclosure is to provide an optical scanning device capable of detecting a motion of a mirror portion at low cost and with high accuracy.

In order to achieve the above object, an optical scanning device of the present disclosure comprises a micromirror device that includes a mirror portion having a reflecting surface for reflecting incident light, a first actuator allowing the mirror portion to swing around a first axis parallel to the reflecting surface in a case in which the mirror portion is stationary, and a second actuator allowing the mirror portion to swing around a second axis parallel to the reflecting surface and orthogonal to the first axis, a light source that emits a light beam, a first photodetection element and a second photodetection element that detect a position in a one-dimensional direction of the light beam reflected by the mirror portion, and a processor that calculates, based on detection signals output from the first photodetection element and the second photodetection element, an amplitude of the mirror portion around the first axis, an amplitude of the mirror portion around the second axis, and a phase difference between the swing of the mirror portion around the first axis and the swing of the mirror portion around the second axis.

It is preferable that the first photodetection element and the second photodetection element each detect a position in a one-dimensional direction of the light beam reflected by the reflecting surface of the mirror portion or a back surface of the mirror portion opposite to the reflecting surface.

It is preferable that the processor causes the mirror portion to perform precession or spiral motion by providing a first drive signal and a second drive signal having the same driving frequency to the first actuator and the second actuator, respectively.

It is preferable that the first photodetection element and the second photodetection element have different position detection directions and are not linear.

It is preferable that a position detection direction of the first photodetection element is parallel to the first axis, and a position detection direction of the second photodetection element is parallel to the second axis.

It is preferable that the processor calculates the phase difference based on a time difference between the detection signal output from the first photodetection element and the detection signal output from the second photodetection element.

It is preferable that the processor calculates a correction amount for setting a motion of the mirror portion to a target motion based on the amplitude around the first axis, the amplitude around the second axis, and the phase difference, and corrects the first drive signal and/or the second drive signal based on the calculated correction amount.

It is preferable that the first photodetection element and the second photodetection element are each a one-dimensional position detection element having a strip-shaped light-receiving surface stretched in one direction.

The first photodetection element and the second photodetection element may each be a photodiode array in which a plurality of photodiodes are arranged in one direction.

According to the technology of the present disclosure, it is possible to provide an optical scanning device capable of detecting a motion of a mirror portion at low cost and with high accuracy.

### BRIEF DESCRIPTION OF THE DRAWINGS

Exemplary embodiments according to the technique of the present disclosure will be described in detail based on the following figures, wherein:

FIG. 1 is a schematic view of an optical scanning device,

FIG. 2 is a block diagram showing an example of a hardware configuration of a driving controller,

FIG. 3 is an external perspective view of a micromirror device,

FIG. 4 is a plan view of the micromirror device as viewed from a light incident side,

FIG. 5 is a plan view of the micromirror device as viewed from a back surface side,

FIG. 6 is a cross-sectional view taken along a line A-A in FIG. 4,

FIG. 7 is a cross-sectional view taken along a line B-B of FIG. 4,

FIG. 8 is a diagram showing an example in which a first actuator is driven in an anti-phase resonance mode,

FIG. 9 is a diagram showing an example in which a second actuator is driven in an anti-phase resonance mode,

FIG. 10 is a diagram showing an example of a drive signal provided to the first actuator and the second actuator,

FIG. 11 is a diagram illustrating a temporal change of a maximum deflection angle,

FIG. 12 is a diagram illustrating precession of a mirror portion,

FIG. 13 is a diagram showing an example of a configuration of a motion detection unit,

FIG. 14 is a block diagram showing an example of functions implemented by a CPU of a control device,

FIG. 15 is a diagram showing an example of detection signals detected by a first photodetection element and a second photodetection element,

FIG. 16 is a graph showing a temporal change of an amplitude and a phase difference in a case in which a trajectory is spiral,

FIG. 17 is a diagram showing another example of detection signals detected by the first photodetection element and the second photodetection element,

FIG. 18 is a graph showing a temporal change of an amplitude and a phase difference in a case in which a trajectory is circular,

FIG. 19 is a diagram showing a motion detection unit according to a first modification example,

FIG. 20 is a diagram showing a motion detection unit according to a second modification example, and

FIG. 21 is a diagram showing a motion detection unit according to a third modification example.

### DETAILED DESCRIPTION

An example of an embodiment according to the technology of the present disclosure will be described with reference to the accompanying drawings.

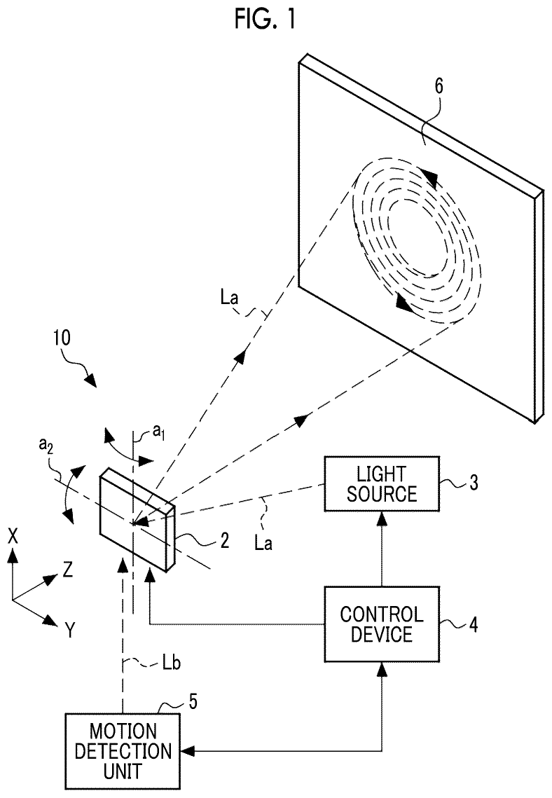

FIG. 1 schematically shows an optical scanning device 10 according to an embodiment. The optical scanning device 10 includes a micromirror device (hereinafter, referred to as MMD) 2, a light source 3, a control device 4, and a motion detection unit 5. The optical scanning device 10 optically scans a surface to be scanned 6 by reflecting a light beam La emitted from the light source 3 with the MMD 2 under the control of the control device 4. The surface to be scanned 6 is, for example, a screen.

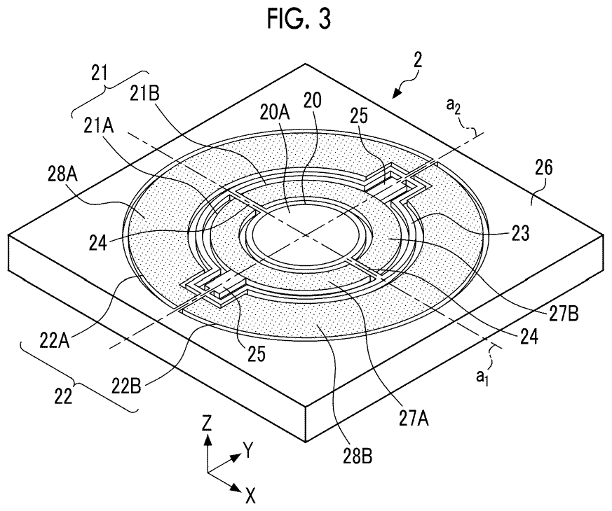

The MMD 2 is a piezoelectric biaxial drive type micromirror device capable of allowing a mirror portion 20 (see FIG. 3) to swing around a first axis a₁ and a second axis a₂ orthogonal to the first axis a₁. Hereinafter, the direction parallel to the first axis a₁ is referred to as an X direction, the direction parallel to the second axis a₂ is a Y direction, and the direction orthogonal to the first axis a₁ and the second axis a₂ is referred to as a Z direction.

The light source 3 is a laser device that emits, for example, laser light as the light beam La. It is preferable that the light source 3 emits the light beam La perpendicularly to a reflecting surface 20A (see FIG. 3) included in the mirror portion 20 in a state where the mirror portion 20 of the MMD 2 is stationary.

The control device 4 outputs a drive signal to the light source 3 and the MMD 2 based on optical scanning information. The light source 3 generates the light beam La based on the input drive signal and emits the light beam La to the MMD 2. The MMD 2 allows the mirror portion 20 to swing around the first axis a₁ and the second axis a₂ based on the input drive signal.

Although described in detail below, in the present embodiment, the control device 4 causes the mirror portion 20 to perform precession or spiral motion. Through the precession of the mirror portion 20, the surface to be scanned 6 is scanned with the light beam La reflected by the mirror portion 20 such that a circular trajectory is traced on the surface to be scanned 6. In addition, through the spiral motion of the mirror portion 20, the surface to be scanned 6 is scanned with the light beam La reflected by the mirror portion 20 such that a spiral trajectory is traced on the surface to be scanned 6, for example. The spiral light beam La is used, for example, in a LiDAR device.

The precession refers to a motion in which a normal line N orthogonal to the reflecting surface 20A of the mirror portion 20 described below traces a circular trajectory. In addition, the spiral motion refers to a motion in which the normal line N traces a spiral trajectory.

As will be described in detail below, the motion detection unit 5 irradiates a back surface side of the mirror portion 20 (that is, a side opposite to a surface on which the light beam La is emitted) with a light beam Lb for detecting the motion of the mirror portion 20, thereby detecting the motion of the mirror portion 20. The control device 4 performs feedback control to maintain the motion of the mirror portion 20 at a target motion, based on a detection signal output from the motion detection unit 5.

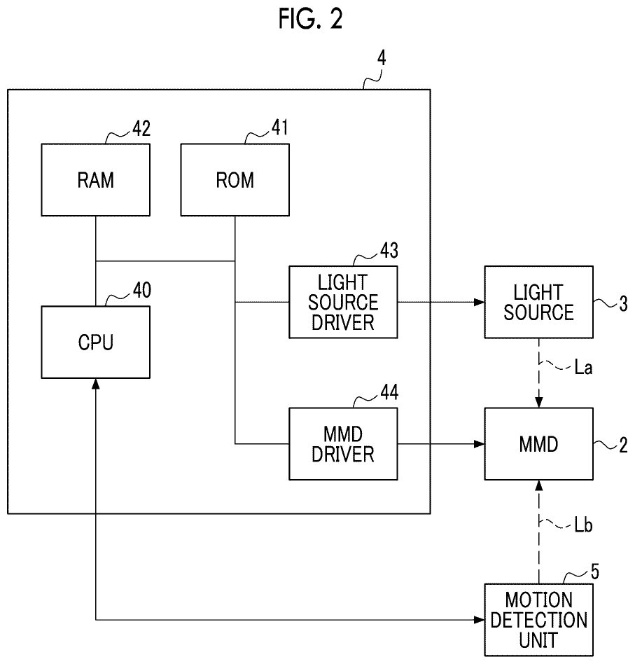

FIG. 2 shows an example of a hardware configuration of the control device 4. The control device 4 includes a central processing unit (CPU) 40, a read only memory (ROM) 41, a random access memory (RAM) 42, a light source driver 43, and an MMD driver 44. The CPU 40 is an arithmetic unit that implements the entire function of the control device 4 by reading out a program and data from a storage device such as the ROM 41 into the RAM 42 and executing processing. The CPU 40 is an example of a “processor” according to the technology of the present disclosure.

The ROM 41 is a non-volatile storage device and stores a program for the CPU 40 to execute processing and data such as the optical scanning information described above. The RAM 42 is a non-volatile storage device that temporarily holds a program and data.

The light source driver 43 is an electric circuit that outputs a drive signal to the light source 3 under the control of the CPU 40. In the light source driver 43, the drive signal is a drive voltage for controlling the irradiation timing and the irradiation intensity of the light source 3.

The MMD driver 44 is an electric circuit that outputs a drive signal to the MMD 2 under the control of the CPU 40. In the MMD driver 44, the drive signal is a drive voltage for controlling the timing, cycle, and deflection angle for allowing the mirror portion 20 of the MMD 2 to swing.

The CPU 40 controls the light source driver 43 and the MMD driver 44 based on the optical scanning information. The optical scanning information is information for indicating how the surface to be scanned 6 is scanned with the light beam La. In the present embodiment, the optical scanning information is information indicating that the surface to be scanned 6 is scanned with the light beam La such that a circular or spiral trajectory is traced on the surface to be scanned 6. For example, in a case in which the optical scanning device 10 is incorporated in the LiDAR device, the optical scanning information includes a timing of performing scanning with the light beam La for distance measurement, a scanning range, and the like.

In addition, the CPU 40 controls the detection operation of the motion detection unit 5, and controls the MMD driver 44 such that the motion of the mirror portion 20 is maintained at a target motion, based on the angle detection signal output from the motion detection unit 5.

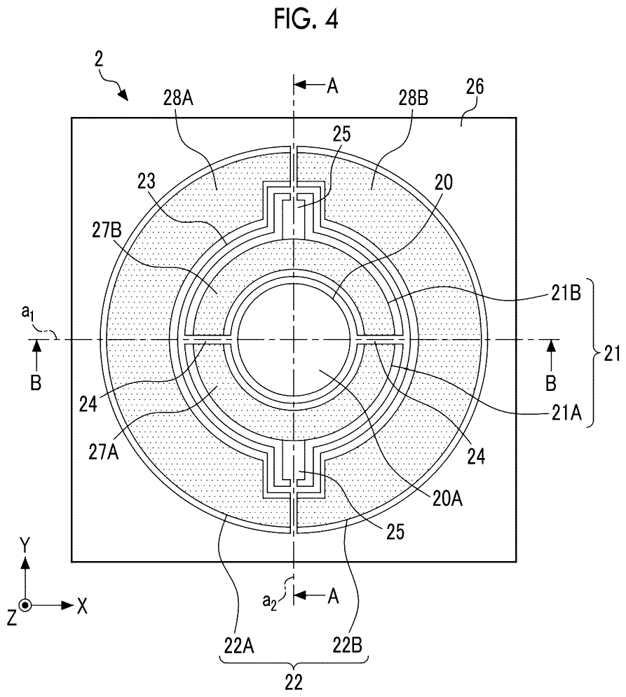

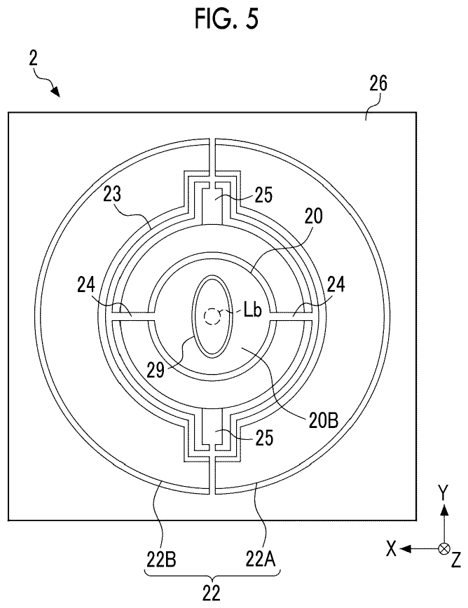

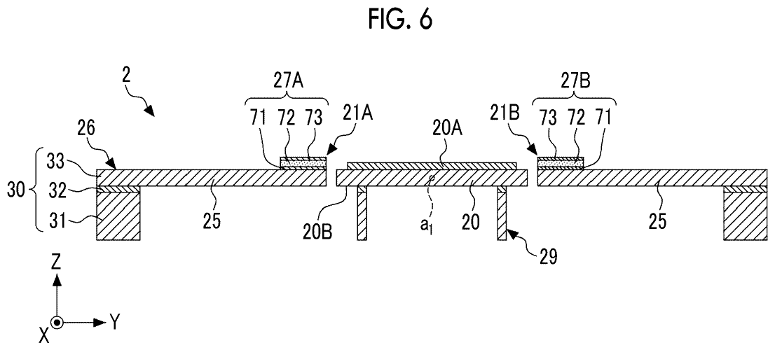

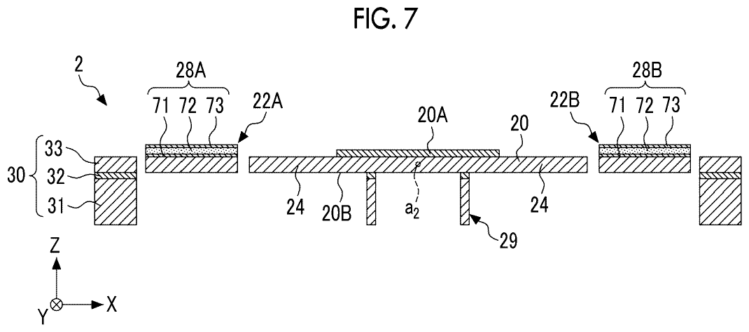

Next, an example of the MMD 2 will be described with reference to FIGS. 3 to 7. FIG. 3 is an external perspective view of the MMD 2. FIG. 4 is a plan view of the MMD 2 as viewed from a light incident side. FIG. 5 is a plan view of the MMD 2 as viewed from a back surface side. FIG. 6 is a cross-sectional view taken along a line A-A in FIG. 4. FIG. 7 is a cross-sectional view taken along a line B-B in FIG. 4.

As shown in FIGS. 3 and 4, the MMD 2 has a mirror portion 20, a first actuator 21, a second actuator 22, a support frame 23, a first support portion 24, a second support portion 25, and a fixed portion 26. The MMD 2 is a so-called MEMS device.

The mirror portion 20 has a reflecting surface 20A for reflecting incident light. The reflecting surface 20A is formed of a metal thin film such as gold (Au) and aluminum (Al) provided on one surface of the mirror portion 20. The reflecting surface 20A is, for example, circular.

The first actuator 21 is disposed to surround the mirror portion 20. The support frame 23 is disposed to surround the mirror portion 20 and the first actuator 21. The second actuator 22 is disposed to surround the mirror portion 20, the first actuator 21, and the support frame 23. The support frame 23 is not an essential component of the technology of the present disclosure.

The first support portion 24 connects the mirror portion 20 and the first actuator 21 on the first axis a₁, and swingably supports the mirror portion 20 around the first axis a₁. The first axis a₁ is parallel to the reflecting surface 20A in a case in which the mirror portion 20 is stationary. For example, the first support portion 24 is a torsion bar stretched along the first axis a₁. In addition, the first support portion 24 is connected to the support frame 23 on the first axis a₁.

The second support portion 25 connects the first actuator 21 and the second actuator 22 on the second axis a₂, and swingably supports the mirror portion 20 and the first actuator 21 around the second axis a₂. The second axis a₂ is parallel to the reflecting surface 20A in a case in which the mirror portion 20 is stationary and is orthogonal to the first axis a₁. The second support portion 25 is connected to the support frame 23 and the fixed portion 26 on the second axis a₂.

The fixed portion 26 is connected to the second actuator 22 by the second support portion 25. The fixed portion 26 has a rectangular outer shape and surrounds the second actuator 22. Lengths of the fixed portion 26 in the X direction and the Y direction are, for example, about 1 mm to 10 mm, respectively. A thickness of the fixed portion 26 in the Z direction is, for example, about 5 μm to 0.2 mm.

The first actuator 21 and the second actuator 22 are piezoelectric actuators each comprising a piezoelectric element. The first actuator 21 applies rotational torque around the first axis a₁ to the mirror portion 20. The second actuator 22 applies rotational torque around the second axis a₂ to the mirror portion 20 and the first actuator 21. Thereby, the mirror portion 20 swings around the first axis a₁ and the second axis a₂.

The first actuator 21 is an annular thin plate member that surrounds the mirror portion 20 in an XY plane. The first actuator 21 is composed of a pair of a first movable portion 21A and a second movable portion 21B. Each of the first movable portion 21A and the second movable portion 21B is semi-annular. The first movable portion 21A and the second movable portion 21B have a shape that is line-symmetrical with respect to the first axis a₁, and are connected on the first axis a₁.

The support frame 23 is an annular thin plate member that surrounds the mirror portion 20 and the first actuator 21 in the XY plane.

The second actuator 22 is an annular thin plate member that surrounds the mirror portion 20, the first actuator 21, and the support frame 23 in the XY plane. The second actuator 22 is composed of a pair of a first movable portion 22A and a second movable portion 22B. Each of the first movable portion 22A and the second movable portion 22B is semi-annular. The first movable portion 22A and the second movable portion 22B have a shape that is line-symmetrical with respect to the second axis a₂, and are connected on the second axis a₂.

In the first actuator 21, the first movable portion 21A and the second movable portion 21B are provided with a piezoelectric element 27A and a piezoelectric element 27B, respectively. In addition, in the second actuator 22, the first movable portion 22A and the second movable portion 22B are provided with a piezoelectric element 28A and a piezoelectric element 28B, respectively.

In FIGS. 3 and 4, a wiring line and an electrode pad for providing the drive signal to the piezoelectric elements 27A, 27B, 28A, and 28B are not shown. A plurality of the electrode pads are provided on the fixed portion 26.

As shown in FIG. 5, an elliptical structure 29 is provided on a back surface 20B of the mirror portion 20. The structure 29 is a so-called rib and is disposed such that the center of the ellipse matches the center of the back surface 20B. A minor axis of the structure 29 is parallel to the X direction, and a major axis thereof is parallel to the Y direction.

A resonance frequency around the first axis a₁ and a resonance frequency around the second axis a₂ of the mirror portion 20 change according to the shape of the structure 29. Therefore, lengths of the structure 29 in a minor axis direction and a major axis direction are determined such that the resonance frequency around the first axis a₁ and the resonance frequency around the second axis a₂ of the mirror portion 20 match each other. The shape of the structure 29 is not limited to an elliptical shape and may be a circular shape or the like.

As shown in FIGS. 6 and 7, the MMD 2 is formed, for example, by performing an etching treatment on a silicon on insulator (SOI) substrate 30. The SOI substrate 30 is a substrate in which a silicon oxide layer 32 is provided on a first silicon active layer 31 made of single crystal silicon, and a second silicon active layer 33 made of single crystal silicon is provided on the silicon oxide layer 32.

The mirror portion 20, the first actuator 21, the second actuator 22, the support frame 23, the first support portion 24, and the second support portion 25 are formed of the second silicon active layer 33 remaining by removing the first silicon active layer 31 and the silicon oxide layer 32 from the SOI substrate 30 by an etching treatment. The second silicon active layer 33 functions as an elastic portion having elasticity. The fixed portion 26 is formed of three layers of the first silicon active layer 31, the silicon oxide layer 32, and the second silicon active layer 33.

The structure 29 is formed by etching the first silicon active layer 31 and the silicon oxide layer 32.

The piezoelectric elements 27A, 27B, 28A, and 28B have a laminated structure in which a lower electrode 71, a piezoelectric film 72, and an upper electrode 73 are sequentially laminated on the second silicon active layer 33. An insulating film is provided on the upper electrode 73, but is not shown.

The upper electrode 73 and the lower electrode 71 are formed of, for example, gold (Au) or platinum (Pt). The piezoelectric film 72 is formed of, for example, lead zirconate titanate (PZT), which is a piezoelectric material. The upper electrode 73 and the lower electrode 71 are electrically connected to the control device 4 described above via the wiring line and the electrode pad.

A drive voltage is applied to the upper electrode 73 from the control device 4. The lower electrode 71 is connected to the control device 4 via the wiring line and the electrode pad, and a reference potential (for example, a ground potential) is applied thereto.

In a case in which a positive or negative voltage is applied to the piezoelectric film 72 in a polarization direction, deformation (for example, expansion and contraction) proportional to the applied voltage occurs. That is, the piezoelectric film 72 exerts a so-called inverse piezoelectric effect. The piezoelectric film 72 exerts an inverse piezoelectric effect by applying a drive voltage from the control device 4 to the upper electrode 73, and displaces the first actuator 21 and the second actuator 22.

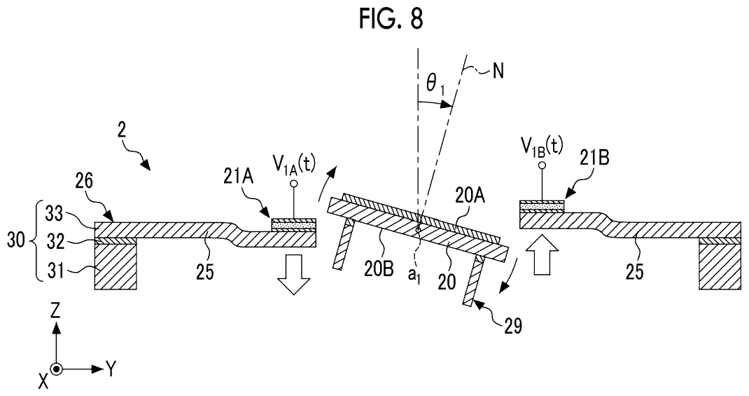

FIG. 8 shows a state in which the first actuator 21 is driven by extending one of the piezoelectric films 72 of the first movable portion 21A and the second movable portion 21B and contracting the other piezoelectric film 72. In this way, the first movable portion 21A and the second movable portion 21B are displaced in opposite directions to each other, whereby the mirror portion 20 rotates around the first axis a₁.

FIG. 8 shows an example in which the first actuator 21 is driven in an anti-phase resonance mode in which the displacement direction of the first movable portion 21A and the second movable portion 21B and the rotation direction of the mirror portion 20 are opposite to each other. In FIG. 8, the first movable portion 21A is displaced in the-Z direction and the second movable portion 21B is displaced in the +Z direction, so that the mirror portion 20 rotates in the +Y direction. The first actuator 21 may be driven in an in-phase resonance mode in which the displacement direction of the first movable portion 21A and the second movable portion 21B and the rotation direction of the mirror portion 20 are the same direction.

An angle at which the normal line N of the reflecting surface 20A of the mirror portion 20 is inclined in a YZ plane is called a first deflection angle θ₁. In a case in which the normal line N of the reflecting surface 20A is inclined in the +Y direction, the first deflection angle θ₁ takes a positive value, and, in a case in which it is inclined in the-Y direction, the first deflection angle θ₁ takes a negative value.

The first deflection angle θ₁ is controlled by the drive signal (hereinafter, referred to as a first drive signal) applied to the first actuator 21 by the control device 4. The first drive signal is, for example, a sinusoidal AC voltage. The first drive signal includes a drive voltage waveform V_{1A}(t) applied to the first movable portion 21A and a drive voltage waveform V_{1B}(t) applied to the second movable portion 21B. The drive voltage waveform V_{1A}(t) and the drive voltage waveform V_{1B}(t) are in an anti-phase with each other (that is, the phase difference is 180°).

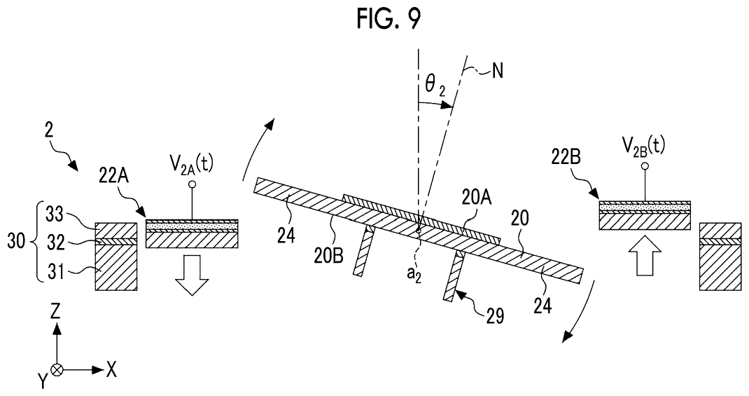

FIG. 9 shows an example in which the second actuator 22 is driven in an anti-phase resonance mode in which the displacement direction of the first movable portion 22A and the second movable portion 22B and the rotation direction of the mirror portion 20 are opposite to each other. In FIG. 9, the first movable portion 22A is displaced in the-Z direction and the second movable portion 22B is displaced in the +Z direction, so that the mirror portion 20 rotates in the +X direction. The second actuator 22 may be driven in an in-phase resonance mode in which the displacement direction of the first movable portion 22A and the second movable portion 22B and the rotation direction of the mirror portion 20 are the same direction.

An angle at which the normal line N of the reflecting surface 20A of the mirror portion 20 is inclined in an XZ plane is called a second deflection angle θ₂. In a case in which the normal line N of the reflecting surface 20A is inclined in the +X direction, the second deflection angle θ₂ takes a positive value, and, in a case in which it is inclined in the −X direction, the second deflection angle θ₂ takes a negative value.

The second deflection angle θ₂ is controlled by the drive signal (hereinafter, referred to as a second drive signal) applied to the second actuator 22 by the control device 4. The second drive signal is, for example, a sinusoidal AC voltage. The second drive signal includes a drive voltage waveform V_{2A}(t) applied to the first movable portion 22A and a drive voltage waveform V_{2B}(t) applied to the second movable portion 22B. The drive voltage waveform V_{2A}(t) and the drive voltage waveform V_{2B}(t) are in an anti-phase with each other (that is, the phase difference is 180°).

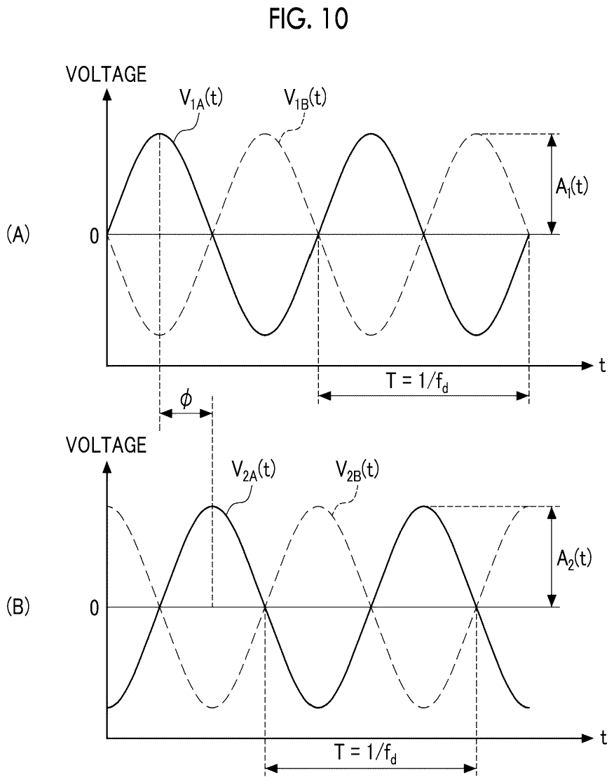

FIG. 10 shows an example of a drive signal provided to the first actuator 21 and the second actuator 22. (A) of FIG. 10 shows the drive voltage waveforms V_{1A}(t) and V_{1B}(t) included in the first drive signal. (B) of FIG. 10 shows the drive voltage waveforms V_{2A}(t) and V_{2B}(t) included in the second drive signal.

The drive voltage waveforms V_{1A}(t) and V_{1B}(t) are represented as follows, respectively.

V_{1A}(t)=A₁(t)sin(2πf_{d}t)

V_{1B}(t)=A₁(t)sin(2πf_{d}t+π)

Here, t is a time. f_{d} is the driving frequency. A₁(t) is an amplitude voltage that changes depending on the time t. A phase difference between the drive voltage waveform V_{1A}(t) and the drive voltage waveform V_{1B}(t) is π (that is, 180°).

By applying the drive voltage waveforms V_{1A}(t) and V_{1B}(t) to the first movable portion 21A and the second movable portion 21B, respectively, the mirror portion 20 swings around the first axis a₁ (see FIG. 8).

The drive voltage waveforms V_{2A}(t) and V_{2B}(t) are represented as follows, respectively.

V_{2A}(t)=A₁(t)sin(2πf_{d}t+φ)

V_{2B}(t)=A₁(t)sin(2πf_{d}t+π+φ)

Here, A₂(t) is an amplitude voltage that changes depending on the time t. A phase difference between the drive voltage waveform V_{2A}(t) and the drive voltage waveform V_{2B}(t) is π (that is, 180°). In addition, q is the phase difference between the drive voltage waveforms V_{1A}(t) and V_{1B}(t) and the drive voltage waveforms V_{2A}(t) and V_{2B}(t). In the present embodiment, φ=π/2 (that is, 90°) is set in order to cause the mirror portion 20 to perform precession or spiral motion.

By applying the drive voltage waveforms V_{2A}(t) and V_{2B}(t) to the first movable portion 22A and the second movable portion 22B, respectively, the mirror portion 20 swings around the second axis a₂ (see FIG. 9).

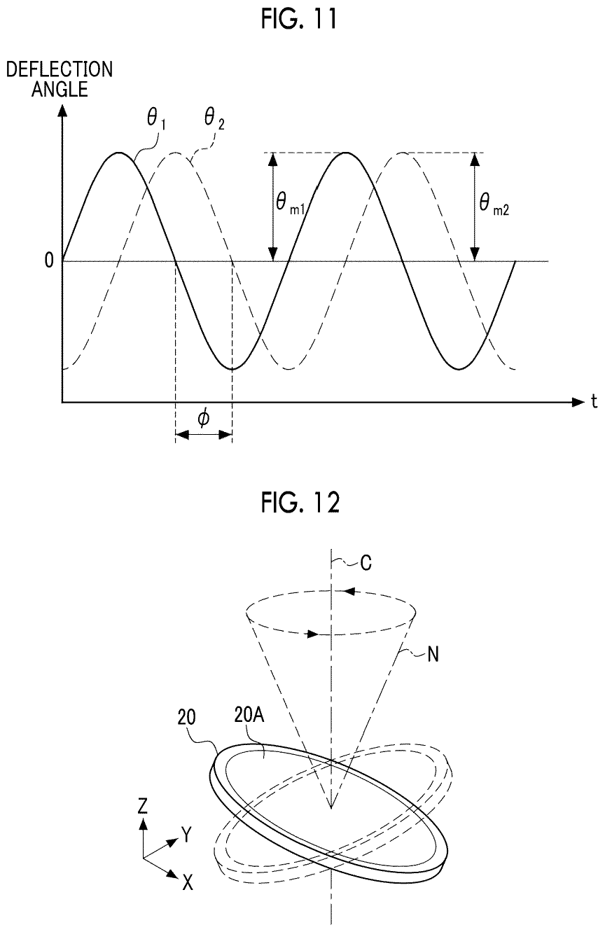

As described above, the first drive signal and the second drive signal have the same driving frequency f_{d} and a phase difference of 90°. In order to cause the mirror portion 20 to perform precession, as shown in FIG. 11, it is necessary to set the amplitude voltages A₁(t) and A₂(t) appropriately such that the maximum deflection angle θₘ₁ of the first deflection angle θ₁ matches the maximum deflection angle θₘ₂ of the second deflection angle θ₂. Since the maximum deflection angle θₘ₁ represents the amplitude of the mirror portion 20 around the first axis a₁, the maximum deflection angle θₘ₁ will be referred to as an amplitude θₘ₁ hereinafter. Similarly, since the maximum deflection angle θₘ₂ represents the amplitude of the mirror portion 20 around the second axis a₂, the maximum deflection angle θₘ₂ will be referred to as an amplitude θₘ₂ hereinafter.

In a case in which the amplitude voltages A₁(t) and A₂(t) are set as constant values independent of the time t, as shown in FIG. 12, the mirror portion 20 performs precession such that the normal line N of the reflecting surface 20A traces a circular trajectory about a rotation axis C parallel to the Z direction. In addition, in a case in which the amplitude voltages A₁(t) and A₂(t) are linearly changed with respect to the time t, the mirror portion 20 performs spiral motion such that the normal line N of the reflecting surface 20A traces a spiral trajectory about the rotation axis C. The amplitude voltages A₁(t) and A₂(t) may be changed to alternately repeat an increase and a decrease with respect to the time t.

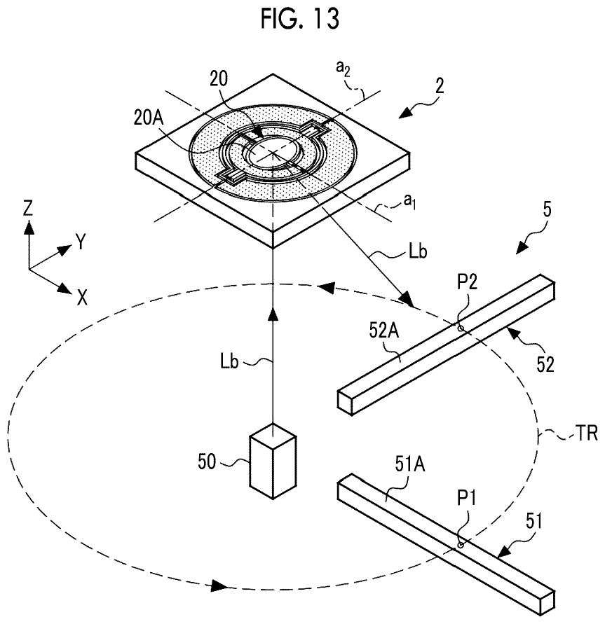

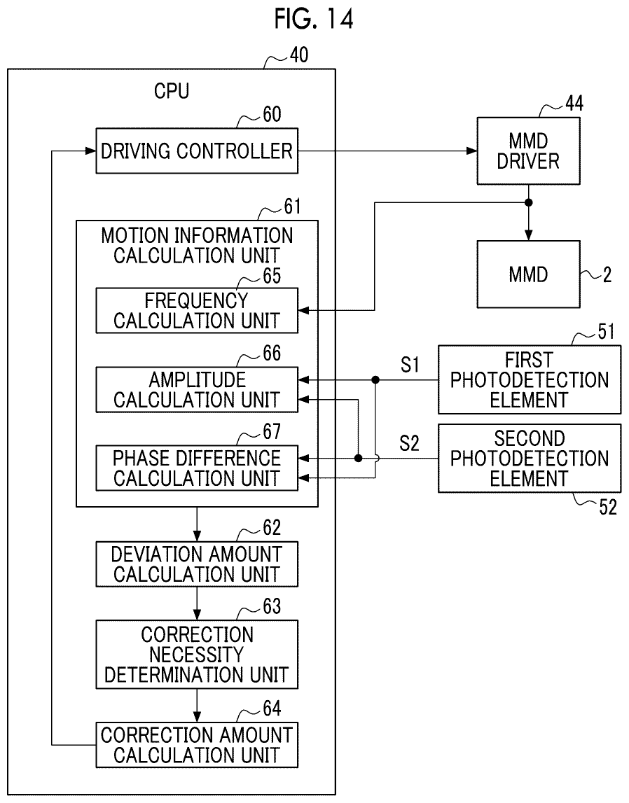

FIG. 13 shows an example of a configuration of the motion detection unit 5. As shown in FIG. 13, the motion detection unit 5 comprises a light source 50, a first photodetection element 51, and a second photodetection element 52. The light source 50 emits a light beam Lb for motion detection. For example, the light source 50 is a laser diode that emits laser light having a wavelength of about 980 nm as the light beam Lb. In the present embodiment, the light source 50 is disposed on the back surface side of the mirror portion 20. The light source 50 emits the light beam Lb perpendicularly to the back surface 20B (see FIG. 5) in a state where the mirror portion 20 is stationary. It is preferable that the light source 50 emits the light beam Lb in a region surrounded by the structure 29 on the back surface 20B.

The first photodetection element 51 is a one-dimensional position detection element that has a strip-shaped light-receiving surface 51A stretched in one direction and that performs position detection of a light-receiving position in a stretching direction of the light-receiving surface 51A. Similarly, the second photodetection element 52 is a one-dimensional position detection element that has a strip-shaped light-receiving surface 52A stretched in one direction and that performs position detection of a light-receiving position in a stretching direction of the light-receiving surface 52A.

The first photodetection element 51 and the second photodetection element 52 have sensitivity in a wavelength range including a wavelength of the light beam Lb. The first photodetection element 51 and the second photodetection element 52 are disposed such that the light-receiving surface 51A and the light-receiving surface 52A are orthogonal to the Z direction and face the back surface 20B of the mirror portion 20.

The light beam Lb emitted from the light source 50 and reflected by the back surface 20B of the mirror portion 20 traces a circular or spiral trajectory TR by the mirror portion 20 performing precession or spiral motion. The first photodetection element 51 and the second photodetection element 52 are disposed at positions through which the trajectory TR passes. The light-receiving surface 51A of the first photodetection element 51 passes through the center of the trajectory TR and is stretched in the X direction (first direction). The light-receiving surface 52A of the second photodetection element 52 passes through the center of the trajectory TR and is stretched in the Y direction (second direction). In the present embodiment, the first photodetection element 51 and the second photodetection element 52 are disposed at positions that are rotationally symmetrical at 90° with respect to the center of the trajectory TR in an XY plane.

In the present embodiment, a position detection direction of the first photodetection element 51 is parallel to the first axis a₁, and a position detection direction of the second photodetection element 52 is parallel to the second axis a₂. As described above, the first photodetection element 51 and the second photodetection element 52 have different position detection directions and are not linear. This is because, in a case in which the position detection directions of the first photodetection element 51 and the second photodetection element 52 are linear, both the first photodetection element 51 and the second photodetection element 52 detect the amplitudes around the same axis. In a case in which the position detection direction of the first photodetection element 51 is the +X direction and the position detection direction of the second photodetection element 52 is the −X direction, both the first photodetection element 51 and the second photodetection element 52 detect the amplitudes around the first axis a₁.

The first photodetection element 51 detects a position P1 at which the light-receiving surface 51A receives the light beam Lb in a case in which the trajectory TR passes through the light-receiving surface 51A, and outputs a detection signal S1 indicating the position P1. The second photodetection element 52 detects a position P2 at which the light-receiving surface 52A receives the light beam Lb in a case in which the trajectory TR passes through the light-receiving surface 52A, and outputs a detection signal S2 indicating the position P2. The position P1 corresponds to the amplitude θₘ₁. The position P2 corresponds to the amplitude θₘ₂. A time difference between a time when the trajectory TR passes through the position P1 and a time when the trajectory TR passes through the position P2 corresponds to a phase difference φ between the swing of the mirror portion 20 around the first axis a₁ and the swing of the mirror portion 20 around the second axis a₂.

The light beam Lb emitted from the light source 50 may be incident on the back surface 20B of the mirror portion 20 via an optical system including a mirror, a lens, and the like.

FIG. 14 shows an example of functions implemented by the CPU 40 of the control device 4. The CPU 40 implements various functions by executing processing based on a program stored in a storage device such as the ROM 41. The CPU 40 functions as a driving controller 60, a motion information calculation unit 61, a deviation amount calculation unit 62, a correction necessity determination unit 63, and a correction amount calculation unit 64. In addition, the motion information calculation unit 61 includes a frequency calculation unit 65, an amplitude calculation unit 66, and a phase difference calculation unit 67.

The driving controller 60 controls the MMD driver 44 to output a first drive signal and a second drive signal for causing the mirror portion 20 to perform a target motion to the MMD 2. The motion information calculation unit 61 calculates information related to the motion of the mirror portion 20. Specifically, the frequency calculation unit 65 calculates the driving frequency f_{d} from the first drive signal and the second drive signal output from the MMD driver 44. The amplitude calculation unit 66 calculates the amplitudes θₘ₁ and θₘ₂ based on the detection signals S1 and S2 output from the first photodetection element 51 and the second photodetection element 52. The phase difference calculation unit 67 calculates the phase difference φ based on the detection signals S1 and S2 output from the first photodetection element 51 and the second photodetection element 52.

The motion information calculation unit 61 need only calculate at least the amplitudes θₘ₁ and θₘ₂ and the phase difference φ. In addition, the phase difference calculation unit 67 can obtain the phase difference φ with high accuracy by using the driving frequency f_{d} in addition to the detection signals S1 and S2.

The deviation amount calculation unit 62 calculates a deviation amount between an actual motion of the mirror portion 20 and a target motion based on the amplitudes θₘ₁ and θₘ₂ and the phase difference φ calculated by the motion information calculation unit 61.

The correction necessity determination unit 63 determines whether or not correction of the first drive signal and/or the second drive signal is necessary based on the deviation amount calculated by the deviation amount calculation unit 62.

In a case in which the correction necessity determination unit 63 determines that the correction is necessary, the correction amount calculation unit 64 calculates a correction amount for correcting the first drive signal and/or the second drive signal based on the amplitudes θₘ₁ and θₘ₂ and the phase difference φ calculated by the motion information calculation unit 61.

The driving controller 60 corrects the first drive signal and/or the second drive signal generated by the MMD driver 44 based on the correction amount calculated by the correction amount calculation unit 64, to set the motion of the mirror portion 20 to the target motion.

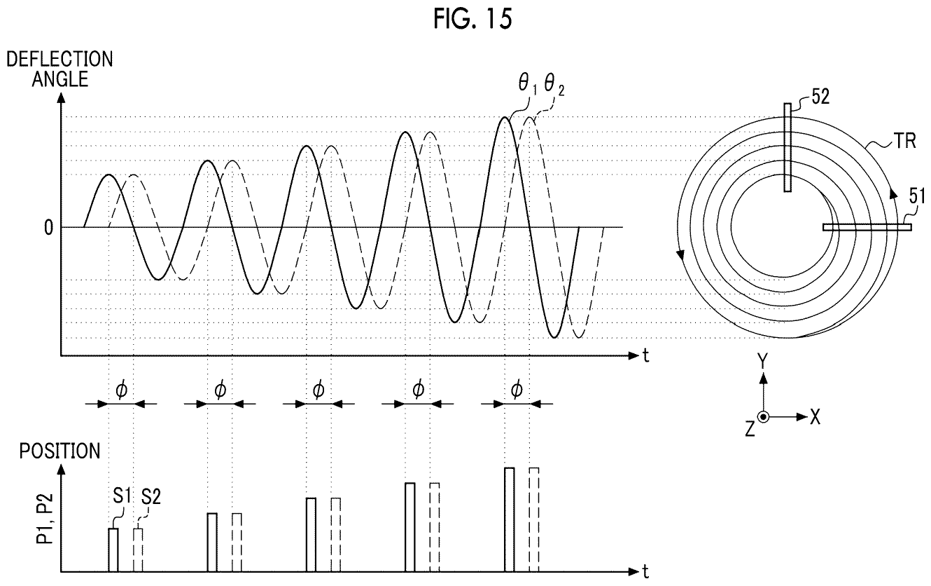

FIG. 15 shows an example of the detection signals S1 and S2 output from the first photodetection element 51 and the second photodetection element 52. In FIG. 15, the trajectory TR is spiral. The first photodetection element 51 outputs the detection signal S1 at a timing at which the trajectory TR passes through the first axis a₁, that is, at a timing at which the first deflection angle θ₁ is maximized. The above-described position P1 is represented by the magnitude of the detection signal S1. Similarly, the second photodetection element 52 outputs the detection signal S2 at a timing at which the trajectory TR passes through the second axis a₂, that is, at a timing at which the second deflection angle θ₂ is maximized. The above-described position P2 is represented by the magnitude of the detection signal S2. The detection signals S1 and S2 are pulsed signals.

The amplitude calculation unit 66 converts the position P1 represented by the magnitude of the detection signal S1 into the amplitude θₘ₁ based on a geometrical positional relationship between the light source 50, the first photodetection element 51, and the mirror portion 20. In addition, the amplitude calculation unit 66 converts the position P2 represented by the magnitude of the detection signal S2 into the amplitude θₘ₂ based on a geometrical positional relationship between the light source 50, the second photodetection element 52, and the mirror portion 20.

The phase difference calculation unit 67 obtains a time difference between the detection signal S1 and the detection signal S2, and converts the time difference into the phase difference P. For example, the phase difference calculation unit 67 obtains a time difference between a rising time of the detection signal S1 and a rising time of the detection signal S2. The phase difference calculation unit 67 may obtain a time difference between a falling time of the detection signal S1 and a falling time of the detection signal S2. In addition, the phase difference calculation unit 67 may obtain a time difference between a median value of the detection signal S1 and a median value of the detection signal S2. The median value is a time halfway between the rising time and the falling time.

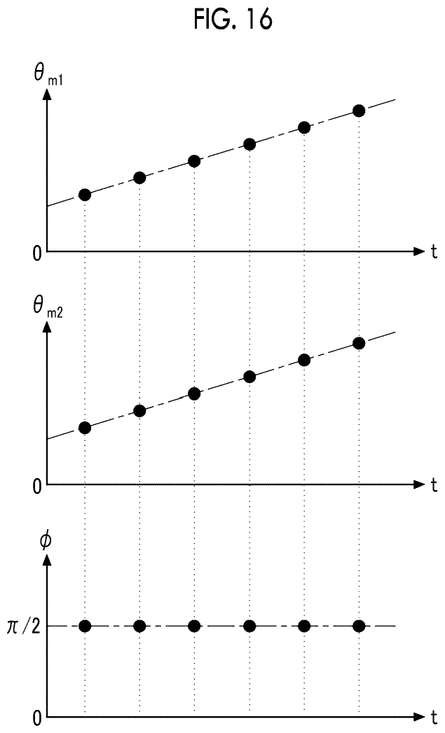

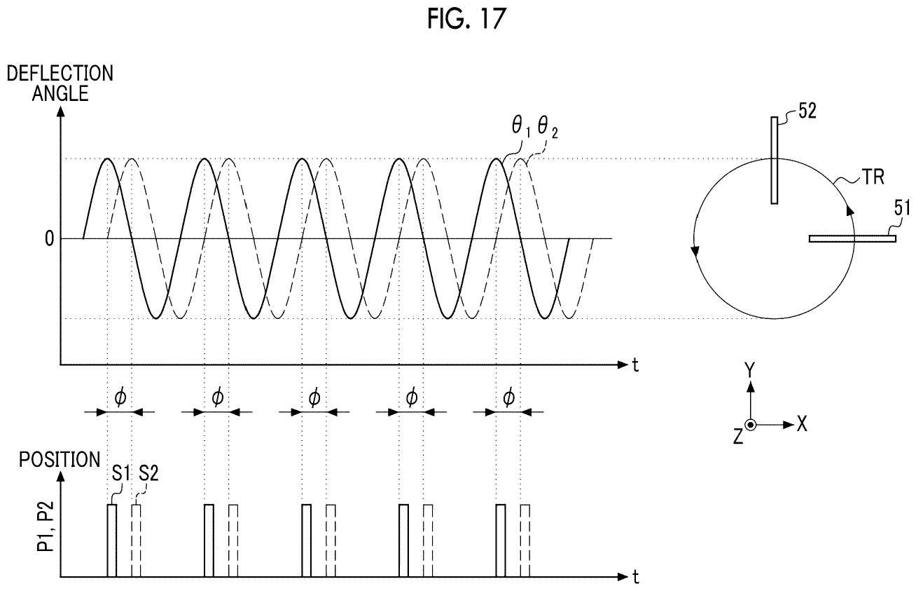

FIG. 16 shows a temporal change of the amplitudes θₘ₁ and θₘ₂ and the phase difference φ in a case in which the trajectory TR is spiral. In a case in which the mirror portion 20 performs the target motion and the trajectory TR is spiral, the amplitudes θₘ₁ and θₘ₂ increase or decrease linearly over time, and the phase difference φ is π/2.

The deviation amount calculation unit 62 calculates a deviation amount between the temporal change of the amplitudes θₘ₁ and θₘ₂ calculated by the amplitude calculation unit 66 and a target linear temporal change. In addition, the deviation amount calculation unit 62 calculates a deviation amount between the phase difference φ calculated by the phase difference calculation unit 67 and the target value π/2.

In a case in which the deviation amount of the amplitude θₘ₁ or the amplitude θₘ₂ exceeds a threshold value or the deviation amount of the phase difference φ exceeds a threshold value, the correction necessity determination unit 63 determines that the correction of the first drive signal and/or the second drive signal is necessary.

In a case in which the deviation amount of the amplitude θₘ₁ exceeds the threshold value, the correction amount calculation unit 64 calculates a correction amount of the amplitude voltage A₁(t) required to set the temporal change of the amplitude θₘ₁ to a target linear temporal change. In addition, in a case in which the deviation amount of the amplitude θₘ₂ exceeds the threshold value, the correction amount calculation unit 64 calculates a correction amount of the amplitude voltage A₂(t) required to set the temporal change of the amplitude θₘ₂ to a target linear temporal change. In addition, in a case in which the deviation amount of the phase difference φ exceeds the threshold value, the correction amount calculation unit 64 calculates a correction amount of a timing between the first drive signal and the second drive signal required to set the phase difference φ to the target value π/2.

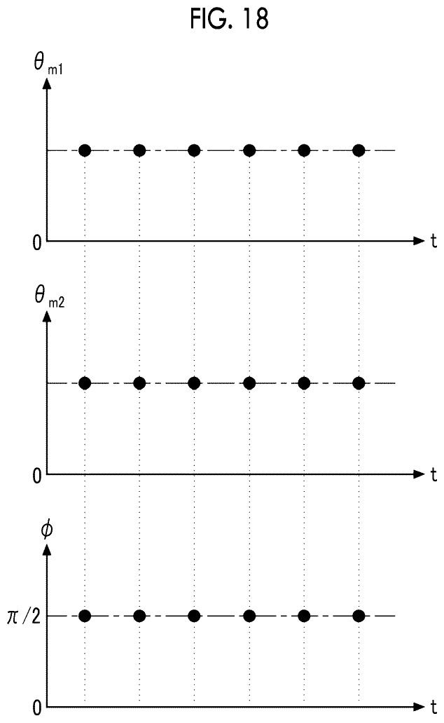

FIG. 17 shows another example of the detection signals S1 and S2 output from the first photodetection element 51 and the second photodetection element 52. In FIG. 17, the trajectory TR is circular. FIG. 18 shows a temporal change of the amplitudes θₘ₁ and θₘ₂ and the phase difference φ in a case in which the trajectory TR is circular.

In a case in which the trajectory TR is circular, the amplitudes θₘ₁ and θₘ₂ are constant values that do not change over time. The deviation amount calculation unit 62 calculates a deviation amount between the amplitudes θₘ₁ and θₘ₂ calculated by the amplitude calculation unit 66 and the target value. Other processing of the control device 4 is the same as in a case in which the trajectory TR is spiral.

As described above, according to the present embodiment, the amplitudes θₘ₁ and θₘ₂ and the phase difference φ of the mirror portion 20 can be detected by using the first photodetection element 51 and the second photodetection element 52 that detect the position in the one-dimensional direction. Therefore, according to the present embodiment, the motion of the mirror portion 20 can be detected at low cost and with high accuracy.

Hereinafter, various modification examples of the above-described embodiment will be described.

### First Modification Example

In the above-described embodiment, the position of the light beam Lb emitted from the light source 50 for motion detection and reflected by the back surface 20B of the mirror portion 20 is detected by the first photodetection element 51 and the second photodetection element 52. Instead of this, the position of the light beam La emitted from the light source 3 and reflected from the reflecting surface 20A of the mirror portion 20 may be detected by the first photodetection element 51 and the second photodetection element 52.

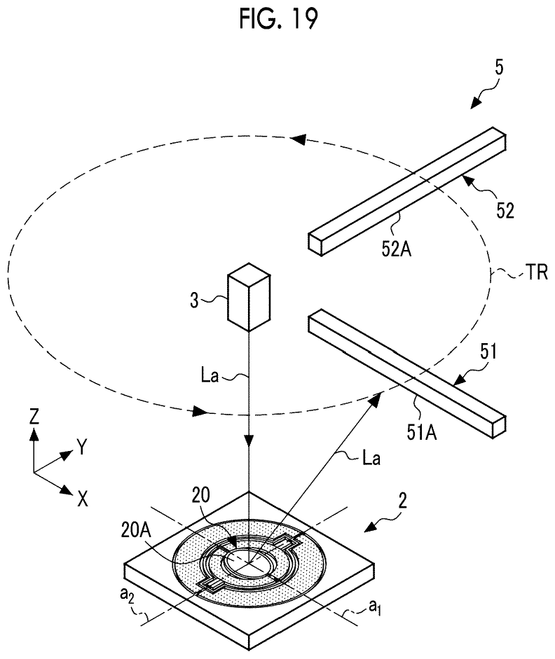

FIG. 19 shows a motion detection unit 5 according to a first modification example. In the present modification example, the motion detection unit 5 includes a first photodetection element 51 and a second photodetection element 52 having the same configuration as in the above-described embodiment. In the present modification example, since the motion of the mirror portion 20 is detected by using the light beam La emitted from the light source 3, the light source 50 for motion detection is not necessary.

In the present modification example, the first photodetection element 51 and the second photodetection element 52 are disposed on a front surface side (that is, the reflecting surface 20A side) of the mirror portion 20. The first photodetection element 51 and the second photodetection element 52 are disposed such that the light-receiving surface 51A and the light-receiving surface 52A are orthogonal to the Z direction and face the reflecting surface 20A of the mirror portion 20. The light-receiving surface 51A of the first photodetection element 51 passes through the center of the trajectory TR of the light beam La and is stretched in the X direction. The light-receiving surface 52A of the second photodetection element 52 passes through the center of the trajectory TR of the light beam La and is stretched in the Y direction.

Other configurations and processing of the optical scanning device according to the present modification example are the same as those in the above-described embodiment.

The light beam La emitted from the light source 3 may be incident on the reflecting surface 20A of the mirror portion 20 via an optical system including a mirror, a lens, and the like.

### Second Modification Example

In addition, in the above-described embodiment, the first photodetection element 51 and the second photodetection element 52 are each a one-dimensional position detection element having a strip-shaped light-receiving surface stretched in one direction. Instead of this, the first photodetection element 51 and the second photodetection element 52 may each be a photodiode array.

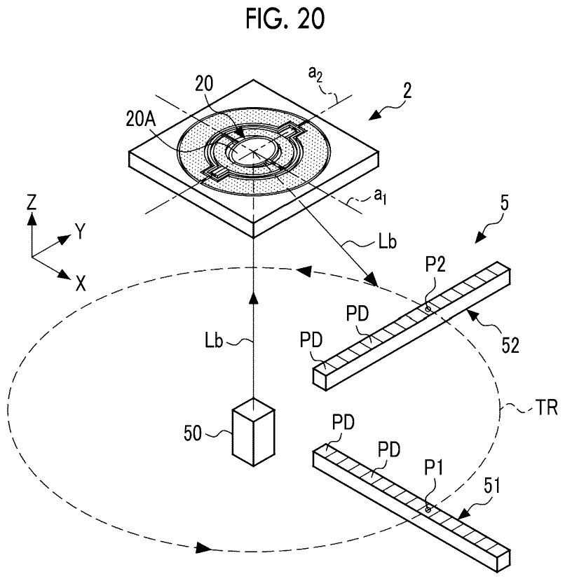

FIG. 20 shows a motion detection unit 5 according to a second modification example. In the present modification example, the first photodetection element 51 and the second photodetection element 52 are each a photodiode array in which a plurality of photodiodes PD are arranged in one direction. In the present modification example, among the plurality of photodiodes PD constituting the first photodetection element 51, a position of the photodiode PD that has received the light beam Lb corresponds to the above-described position P1. Similarly, among the plurality of photodiodes PD constituting the second photodetection element 52, a position of the photodiode PD that has received the light beam Lb corresponds to the above-described position P2.

The first photodetection element 51 outputs a detection signal S1 indicating the position of the photodiode PD that has received the light beam Lb. The second photodetection element 52 outputs a detection signal S2 indicating the position of the photodiode PD that has received the light beam Lb.

Other configurations and processing of the optical scanning device according to the present modification example are the same as those in the above-described embodiment.

The first photodetection element 51 and the second photodetection element 52 included in the motion detection unit 5 (see FIG. 19) according to the first modification example may each be a photodiode array.

### Third Modification Example

In addition, in the above-described embodiment, the motion detection unit 5 includes two photodetection elements, but may include three or more photodetection elements that detect the position in the one-dimensional direction.

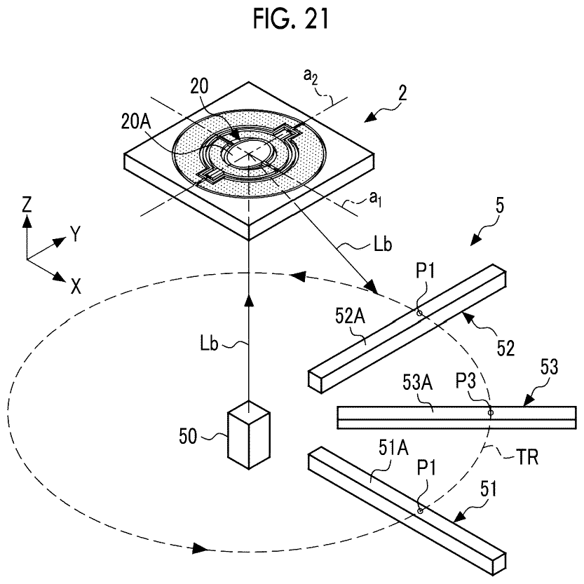

FIG. 21 shows a motion detection unit 5 according to a third modification example. In the present modification example, in addition to the first photodetection element 51 and the second photodetection element 52, a third photodetection element 53 is provided. The first photodetection element 51 and the second photodetection element 52 have the same configuration as in the above-described embodiment.

The third photodetection element 53 is a one-dimensional position detection element that has a strip-shaped light-receiving surface 53A stretched in one direction and that performs position detection of a light-receiving position in a stretching direction of the light-receiving surface 53A. The light-receiving surface 53A of the third photodetection element 53 passes through the center of the trajectory TR and is stretched in a direction (third direction) that forms an angle of 45° with the X direction and the Y direction. The third photodetection element 53 detects a position P3 at which the light-receiving surface 53A receives the light beam Lb in a case in which the trajectory TR passes through the light-receiving surface 53A, and outputs a detection signal S3 indicating the position P3.

In the present modification example, the amplitude calculation unit 66 calculates the amplitudes θₘ₁ and θₘ₂ based on the detection signals S1, S2, and S3 output from the first photodetection element 51, the second photodetection element 52, and the third photodetection element 53. The phase difference calculation unit 67 calculates the phase difference φ based on the detection signals S1, S2, and S3. As described above, by using the detection signal S3 in addition to the detection signals S1 and S2, the amplitudes θₘ₁ and θₘ₂ and the phase difference φ can be calculated with higher accuracy.

In a case in which three or more photodetection elements are provided in the motion detection unit 5, it is preferable that the position detection directions of any two photodetection elements among the three or more photodetection elements are not linear.

In addition, in the above-described embodiment, the position detection direction of the first photodetection element 51 is the X direction, and the position detection direction of the second photodetection element 52 is the Y direction, but the present invention is not limited to this, and the position detection direction of the first photodetection element 51 and the position detection direction of the second photodetection element 52 need only be different directions and not in a straight line.

### Other Modification Examples

The configuration of the MMD 2 shown in the above-described embodiment can be changed as appropriate. For example, in the above-described embodiment, although the first actuator 21 and the second actuator 22 have an annular shape, one or both of the first actuator 21 and the second actuator 22 may have a meander structure. In addition, it is possible to use a support member having a configuration other than a torsion bar as the first support portion 24 and the second support portion 25.

In addition, various modifications can be made to a hardware configuration of the control device 4. A processing unit of the control device 4 may be configured of one processor, or may be configured of a combination of two or more processors of the same type or different types (for example, a combination of a plurality of field programmable gate arrays (FPGAs) and/or a combination of a CPU and an FPGA). For example, the driving controller 60, the motion information calculation unit 61, the deviation amount calculation unit 62, the correction necessity determination unit 63, and the correction amount calculation unit 64 of the above-described embodiment may be configured by one or two or more processors.

The above-described embodiment and respective modification examples can be combined as appropriate as long as there is no contradiction.

All documents, patent applications, and technical standards mentioned in this specification are incorporated herein by reference to the same extent as in a case where each document, each patent application, and each technical standard are specifically and individually described by being incorporated by reference.

What is claimed is:

1. An optical scanning device comprising:
a micromirror device that includes a mirror portion having a reflecting surface for reflecting incident light, a first actuator allowing the mirror portion to swing around a first axis parallel to the reflecting surface in a case in which the mirror portion is stationary, and a second actuator allowing the mirror portion to swing around a second axis parallel to the reflecting surface and orthogonal to the first axis;
a light source that emits a light beam;
a first photodetection element and a second photodetection element that detect a position in a one-dimensional direction of the light beam reflected by the mirror portion; and
a processor that calculates, based on detection signals output from the first photodetection element and the second photodetection element, an amplitude of the mirror portion around the first axis, an amplitude of the mirror portion around the second axis, and a phase difference between the swing of the mirror portion around the first axis and the swing of the mirror portion around the second axis.

2. The optical scanning device according to claim 1,
wherein the first photodetection element and the second photodetection element each detect a position in a one-dimensional direction of the light beam reflected by the reflecting surface of the mirror portion or a back surface of the mirror portion opposite to the reflecting surface.

3. The optical scanning device according to claim 1,
wherein the processor causes the mirror portion to perform precession or spiral motion by providing a first drive signal and a second drive signal having the same driving frequency to the first actuator and the second actuator, respectively.

4. The optical scanning device according to claim 3,
wherein the first photodetection element and the second photodetection element have different position detection directions and are not linear.

5. The optical scanning device according to claim 4,
wherein a position detection direction of the first photodetection element is parallel to the first axis, and a position detection direction of the second photodetection element is parallel to the second axis.

6. The optical scanning device according to claim 4,
wherein the processor calculates the phase difference based on a time difference between the detection signal output from the first photodetection element and the detection signal output from the second photodetection element.

7. The optical scanning device according to claim 4,
wherein the processor
calculates a correction amount for setting a motion of the mirror portion to a target motion based on the amplitude around the first axis, the amplitude around the second axis, and the phase difference, and
corrects the first drive signal and/or the second drive signal based on the calculated correction amount.

8. The optical scanning device according to claim 1,
wherein the first photodetection element and the second photodetection element are each a one-dimensional position detection element having a strip-shaped light-receiving surface stretched in one direction.

9. The optical scanning device according to claim 1,
wherein the first photodetection element and the second photodetection element are each a photodiode array in which a plurality of photodiodes are arranged in one direction.
